(19) United States
(12) Patent Application Publication
(10) Pub. No.: US 2013/0328851 A1
(43) Pub. Date: Dec. 12, 2013

(54) GROUND NOISE PROPAGATION REDUCTION FOR AN ELECTRONIC DEVICE

(71) Applicants: Ahmad Al-Dahle, Santa Clara, CA (US); Shafiq M. Jamal, Pleasanton, CA (US)

(72) Inventors: Ahmad Al-Dahle, Santa Clara, CA (US); Shafiq M. Jamal, Pleasanton, CA (US)

(73) Assignee: APPLE INC., Cupertino, CA (US)

(21) Appl. No.: 13/599,950

(22) Filed: Aug. 30, 2012

Related U.S. Application Data
(60) Provisional application No. 61/657,676, filed on Jun. 8, 2012.

(51) Int. Cl. G09G 5/00; G05F 3/02

(52) U.S. Cl. 345/212; 327/536

(57) ABSTRACT

A system and device for reducing ground bounce in circuitry. Utilization of a common ground supplied to multiple integrated circuits reduces the complexity and costs of producing circuitry but tends to interfere with signal quality within the circuitry by subjecting each integrated circuit to the ground bounce of every other integrated circuit. By introducing a source follower to selectively decouple and/or couple slave circuits within the circuitry, the ground bounce for the overall system can be reduced, thereby increasing the efficiency of interpreting signals within the circuitry.

### CROSS REFERENCE TO RELATED APPLICATIONS

This application is a Non-Provisional patent application of U.S. Provisional Patent Application No. 61/657,676, entitled “Ground Noise Propagation Reduction for an Electronic Device”, filed Jun. 8, 2012, which are herein incorporated by reference.

### BACKGROUND

The present disclosure relates generally to reducing ground bounce propagation in electronic devices.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Ground bounce occurs in most electronic devices containing integrated circuits. Ground bounce is a voltage oscillation at the negative terminal of an integrated circuit. This voltage oscillation negatively affects the output of electrical component. Specifically, ground bounce is one of the major causes of decreased signal quality in electronic components. Furthermore, ground bounce may cause the output of the electronic component to be interpreted incorrectly. Additionally, when multiple electronic components share a common return, ground bounce noise occurring on one electronic component may be propagated to the other electronic components.

One method of reducing ground noise propagation may include a separate ground connection for each component. However, the inclusion of common ground connections between electronic components increase the cost, size, stability, and complexity of the circuitry in the electronic device as compared to equivalent circuits using common ground connections. Accordingly, there is a need for reducing the propagation of ground bounce between multiple electronic components connected to a common return.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

A system and device for reducing ground bounce in circuitry. Utilization of a common ground supplied to multiple integrated circuits reduces the complexity and costs of producing circuitry but tends to interfere with signal quality within the circuitry by subjecting each integrated circuit to the ground bounce of every other integrated circuit. In certain integrated circuits, when one or more gates in the integrated circuit switch from a logic one to a logic zero, a voltage differential between the integrated ground and the common ground arises. Due to this voltage differential, a current builds then recedes causing the common ground to rise and then fall as a ground bounce. This current can cause the common ground voltage to fluctuate as a ground bounce to interfere with signals in other circuitry by causing a misinterpretation of logic voltages. By introducing a source follower to selectively decouple and/or couple slave circuits within the circuitry, the ground bounce for the overall system can be reduced, thereby increasing the efficiency of interpreting signals within the circuitry.

### BRIEF DESCRIPTION OF THE DRAWINGS

Various aspects of this disclosure may be better understood upon reading the following detailed description and upon reference to the drawings in which:

FIG. 1 is a block diagram of an electronic device in accordance with aspects of the present disclosure;

FIG. 2 is a perspective view of a cellular device in accordance with aspects of the present disclosure;

FIG. 3 is a perspective view of a handheld electronic device in accordance with aspects of the present disclosure;

FIG. 4 is a schematic view of display circuitry found in the display;

FIG. 5 is a schematic view of a source amplifier circuit that may be found in the electronic device of FIG. 1;

FIG. 6A graphically depicts the voltage at the negative terminal of the source amplifier that may be found in the circuit of FIG. 5;

FIG. 6B graphically depicts the voltage at the output terminal of the source amplifier that may be found in the circuit of FIG. 5;

FIG. 7 is a schematic view of a source amplifier circuit that may be found in the electronic device of FIG. 1 in accordance with aspects of the present disclosure;

FIG. 8 is a detailed schematic view of an embodiment of the source amplifier circuitry of FIG. 7 in accordance with aspects of the present disclosure;

FIG. 9 is a more detailed schematic view of an embodiment of the source amplifier circuitry of FIG. 7 in accordance with aspects of the present disclosure;

FIG. 10 is a schematic view of an embodiment of the charge pump of FIG. 8 in accordance with aspects of the present disclosure;

FIG. 11A is a graph illustrating an embodiment of a clock signal that may be found in the charge pump of FIG. 10 in accordance with aspects of the present disclosure;

FIG. 11B is a graph illustrating an embodiment of a voltage internal to the charge pump of FIG. 10 in accordance with aspects of the present disclosure;

FIG. 11C is a graph illustrating an embodiment of an output voltage from the charge pump of FIG. 10 in accordance with aspects of the present disclosure; and

FIG. 12 is a flow chart of a method of reducing ground bounce in accordance with aspects of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Certain embodiments of the present disclosure are directed to reducing the negative affects of ground bounce in electronic devices. Ground bounce is one of the major causes of false switching and reduced signal quality. Additionally, when multiple electronic components share a common return, ground bounce noise occurring on one electronic component may be propagated to the other electronic components. For example, one technique for reducing ground bounce propagation includes using a charge pump regulator couple or decouple a master circuit to or from ground. The charge pump regulator senses a voltage that emulates a selected voltage from the master circuit. The charge pump regulator compares the sensed voltage to a reference voltage. When the voltages are equal, the charge pump regulator propagates a gate voltage to the master circuit and one or more slave circuits. The propagated gate voltages cause the negative terminals of the source amplifiers in the master and slave circuits to couple to ground. When the voltages are not equal, the charge pump regulator adjusts an internal voltage that blocks propagation of the gate voltage. In other words, when the reference voltage does not equal the sensed voltage, the negative terminals of the source amplifiers are decoupled from ground to prevent propagation of noise to other circuits.

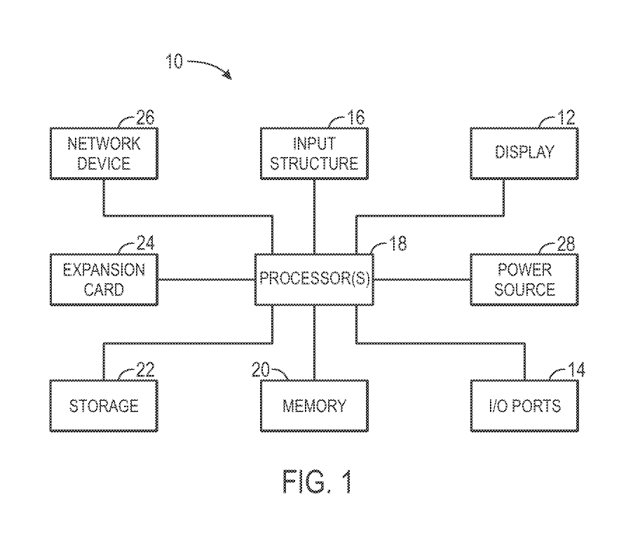

As may be appreciated, electronic devices may include various internal and/or external components which contribute to the function of the device. For instance, FIG. 1 is a block diagram illustrating components that may be present in one such electronic device 10. Those of ordinary skill in the art will appreciate that the various functional blocks shown in FIG. 1 may include hardware elements (including circuitry), software elements (including computer code stored on a computer-readable medium, such as a hard drive or system memory), or a combination of both hardware and software elements. FIG. 1 is only one example of a particular implementation and is merely intended to illustrate the types of components that may be present in the electronic device 10. For example, in the presently illustrated embodiment, these components may include a display 12, input/output (I/O) ports 14, input structures 16, one or more processors 18, one or more memory devices 20, nonvolatile storage 22, expansion card(s) 24, networking device 26, and power source 28.

The display 12 may be used to display various images generated by the electronic device 10. The display 12 may be any suitable display, such as a liquid crystal display (LCD) or an organic light-emitting diode (OLED) display. Additionally, in certain embodiments of the electronic device 10, the display 12 may be provided in conjunction with a touch-sensitive element, such as a touchscreen, that may be used as part of the control interface for the device 10.

The I/O ports 14 may include ports configured to connect to a variety of external devices, such as a power source, headset or headphones, or other electronic devices (such as handheld devices and/or computers, printers, projectors, external displays, modems, docking stations, and so forth). The I/O ports 14 may support any interface type, such as a universal serial bus (USB) port, a video port, a serial connection port, an IEEE-1394 port, a speaker, an Ethernet or modem port, and/or an AC/DC power connection port.

The input structures 16 may include the various devices, circuitry, and pathways by which user input or feedback is provided to processor(s) 18. Such input structures 16 may be configured to control a function of an electronic device 10, applications running on the device 10, and/or any interfaces or devices connected to or used by device 10. For example, input structures 16 may allow a user to navigate a displayed user interface or application interface. Non-limiting examples of input structures 16 include buttons, sliders, switches, control pads, keys, knobs, scroll wheels, keyboards, mice, touchpads, microphones, and so forth. Additionally, in certain embodiments, one or more input structures 16 may be provided together with display 12, such as in the case of a touchscreen using Multi-Touch™, in which a touch sensitive mechanism is provided in conjunction with display 12.

Processors 18 may provide the processing capability to execute the operating system, programs, user and application interfaces, and any other functions of the electronic device 10. The processors 18 may include one or more microprocessors, such as one or more “general-purpose” microprocessors, one or more special-purpose microprocessors or ASICS, or some combination of such processing components. For example, the processors 18 may include one or more reduced instruction set (RISC) processors, as well as graphics processors, video processors, audio processors, and the like. As will be appreciated, the processors 18 may be communicatively coupled to one or more data buses or chipsets for transferring data and instructions between various components of the electronic device 10.

Programs or instructions executed by processor(s) 18 may be stored in any suitable manufacture that includes one or more tangible, computer-readable media at least collectively storing the executed instructions or routines, such as, but not limited to, the memory devices and storage devices described below. Also, these programs (e.g., an operating system) encoded on such a computer program product may also include instructions that may be executed by the processors 18 to enable device 10 to provide various functionalities, including those described herein.

The instructions or data to be processed by the one or more processors 18 may be stored in a computer-readable medium, such as a memory 20. The memory 20 may include a volatile memory, such as random access memory (RAM), and/or a non-volatile memory, such as read-only memory (ROM). The memory 20 may store a variety of information and may be used for various purposes. For example, the memory 20 may store firmware for electronic device 10 (such as basic input/output system (BIOS)), an operating system, and various other programs, applications, or routines that may be executed on electronic device 10. In addition, the memory 20 may be used for buffering or caching during operation of the electronic device 10.

The components of the device 10 may further include other forms of computer-readable media, such as non-volatile storage 22 for persistent storage of data and/or instructions. Non-volatile storage 22 may include, for example, flash memory, a hard drive, or any other optical, magnetic, and/or solid-state storage media. Non-volatile storage 22 may be used to store firmware, data files, software programs, wireless connection information, and any other suitable data.

The embodiment illustrated in FIG. 1 may also include one or more card or expansion slots. The card slots may be configured to receive one or more expansion cards 24 that may be used to add functionality, such as additional memory, I/O functionality, or networking capability, to electronic device 10. Such expansion cards 24 may connect to device 10 through any type of suitable connector, and may be accessed internally or external to the housing of electronic device 10. For example, in one embodiment, expansion cards 24 may include a flash memory card, such as a SecureDigital (SD) card, mini- or microSD, CompactFlash card, Multimedia card (MMC), or the like. Additionally, expansion cards 24 may include one or more processor(s) 18 of the device 10, such as a video graphics card having a GPU for facilitating graphical rendering by device 10.

The components depicted in FIG. 1 also include a network device 26, such as a network controller or a network interface card (NIC). In one embodiment, the network device 26 may be a wireless NIC providing wireless connectivity over any 802.11 standard or any other suitable wireless networking standard. The device 10 may also include a power source 28. In one embodiment, the power source 28 may include one or more batteries, such as a lithium-ion polymer battery or other type of suitable battery. Additionally, the power source 28 may include AC power, such as provided by an electrical outlet, and electronic device 10 may be connected to the power source 28 via a power adapter. This power adapter may also be used to recharge one or more batteries of device 10.

The electronic device 10 may take the form of a computer system or some other type of electronic device. Such computers may include computers that are generally portable (such as laptop, notebook, tablet, and handheld computers), as well as computers that are generally used in one place (such as conventional desktop computers, workstations and/or servers). In certain embodiments, electronic device 10 in the form of a computer may include a model of a MacBook®, MacBook® Pro, MacBook Air®, iMac®, Mac® mini, or Mac® Pro available from Apple Inc. of Cupertino, Calif.

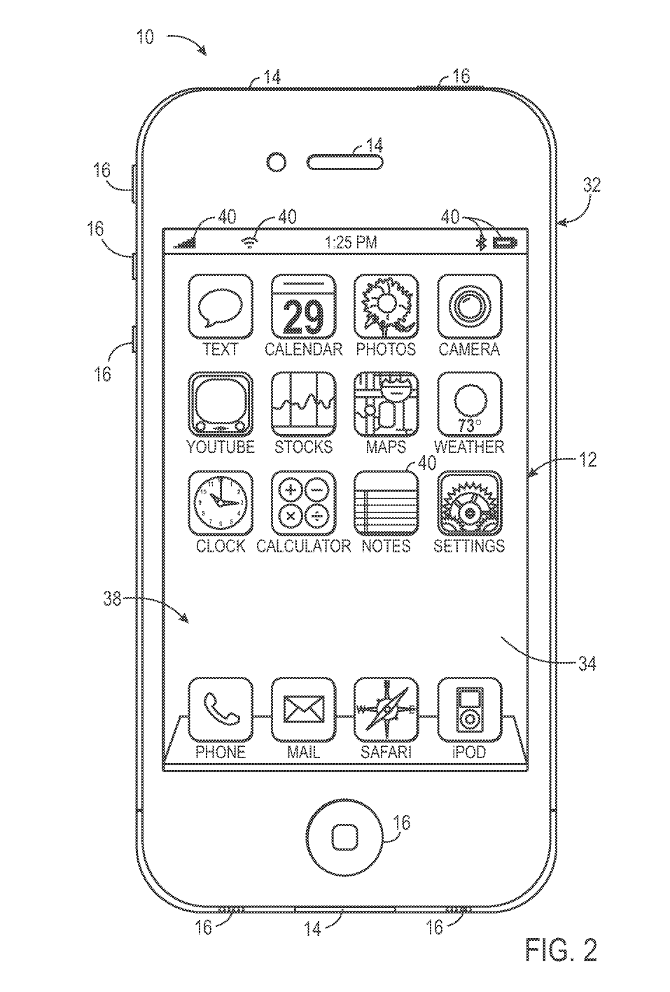

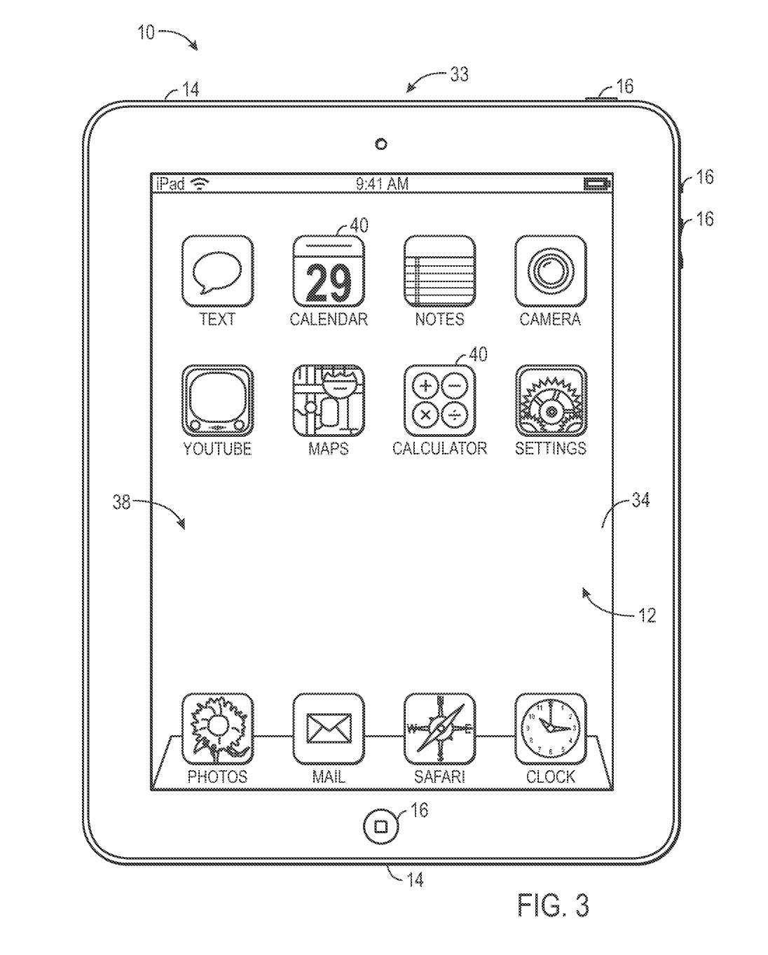

The electronic device 10 may also take the form of other types of electronic devices. In some embodiments, various electronic devices 10 may include mobile telephones, media players, personal data organizers, handheld game platforms, cameras, and combinations of such devices. For instance, as generally depicted in FIG. 2, the device 10 may be provided in the form of a cellular device 32 that includes various functionalities (such as the ability to take pictures, make telephone calls, access the Internet, communicate via email, record audio and video, listen to music, play games, and connect to wireless networks). Alternatively, as depicted in FIG. 3, the electronic device 10 may be provided in the form of a handheld electronic device 33. By way of further example, handheld device 36 may be a model of an iPhone®, iPod®, or iPad® available from Apple Inc. of Cupertino, Calif.

The electronic device 10 of the presently illustrated embodiment includes a display 12, which may be in the form of an LCD 34. The LCD 34 may display various images generated by electronic device 10, such as a graphical user interface (GUI) 38 having one or more icons 40. In one embodiment, the LCD 34 may be a high resolution display with 1000 or more horizontal gate lines present therein. The device 36 may also include various I/O ports 14 to facilitate interaction with other devices, and user input structures 16 to facilitate interaction with a user.

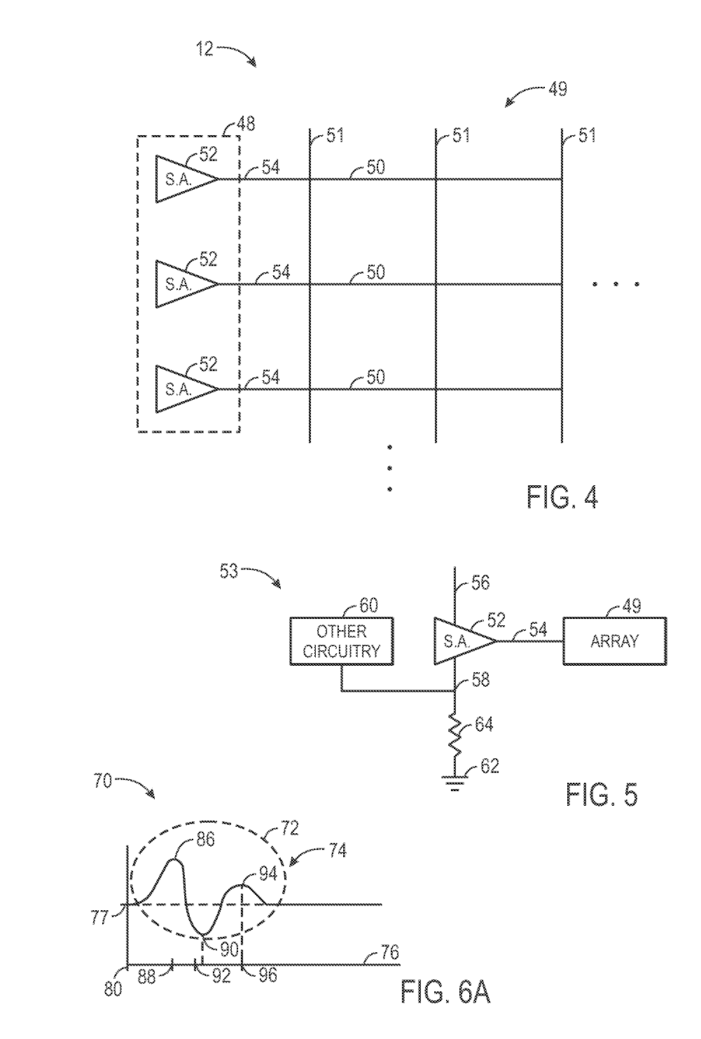

Referring now to FIG. 4, an example of a circuit view of display circuitry found in a display 12 is provided. In certain embodiments, such circuitry as depicted in FIG. 5 may include a TFT layer. The display 12 may include one or more source amplifier circuits 48 sending a signal to a display array 49. The display array 49 includes multiple data lines 50 and multiple scanning lines 51. As can be appreciated, in such an array, each intersection of a data line 50 and a scanning line 51 may define a pixel of the display. Additionally, the data lines 50 and/or scanning lines 51 may be driven by one or more amplified signals 54 provided by the source amplifier circuits 48. The source amplifier circuits 48 include an array of source amplifiers 52 configured to amplify an amplified signal 54 to a desired amplitude suitable for driving the array 49. The array 49 of pixels receives the amplified signals 54 from the source amplifier circuits 48 to produce a desired image for the display 12.

One example of a source amplifier circuit 48 from FIG. 4 is depicted in FIG. 5 that may be included in the display 12. The illustrated source amplifier circuit 48 includes a source amplifier 52 amplifying a signal as an amplified signal 54. In certain embodiments, the source amplifier 52 may be any amplifier suitable for amplifying a signal, such as a circuit incorporating one or more integrated circuits. Also, as illustrated, the source amplifier 52 provides the amplified signal 54 to the array 49, for example, a drive signal for the display array 49. Alternatively or additionally, other embodiments of the source amplifier circuit 48 may include supplying the amplified signal 54 to other electronic components, such as the processor(s) 18, storage 22, other components, or a combination thereof. Additionally, the source amplifier 52 is connected to a voltage 56 supplied by a suitable source. For example, in some embodiments, the voltage 56 may be supplied at the positive terminal of the source amplifier 52 as 18V, 5V, 3.3V, 1.8 V, or another suitable voltage. The source amplifier 52 may also be connected to a common return 58 at a positive/negative terminal of the source amplifier 52 (e.g., local ground, −Vdd). As illustrated, the common return 58 may be common with other circuitry 60. Furthermore, the common return 58 may be configured to be connected to an earth ground 62 to provide a ground connection to the source amplifier circuit 52 and the other circuitry 60. In some embodiments, various electrical properties of the path between the earth ground 62 and common return 58 may cause common return 58 to propagate electromagnetic noise between the source amplifier 52 and the other circuitry 60. For example, resistor 64 may represent the relatively high impedance of a pad used to connect an electronic chip to the glass of the display 12. As discussed below, propagating noise on the common return 58 of the electronic device may decrease performance of the display 12, source amplifier 52, and/or other circuitry 60.

As the demand for higher speed devices increases, the demand for faster switching components increases. In order to achieve faster responses, the source amplifier 52 may include fast switching integrated circuits, such as those including Bipolar Junction Transistors (BJT), Fast CMOS Technologies (FCT), or other similar technologies. Integrated circuits, such as those that may be included in the source amplifier 52, typically include multiple logic gates in one chip. When a gate switches from a logic HIGH to a logic LOW, voltage oscillation or ground bounce may occur at the negative terminal of the chip due to a current surge through the lead inductance of the chip (i.e., inductive ringing). As may be appreciated, the ground bounce characteristic of a chip becomes greater when multiple gates are switched simultaneously due to more current surging through the lead inductance of the integrated circuit.

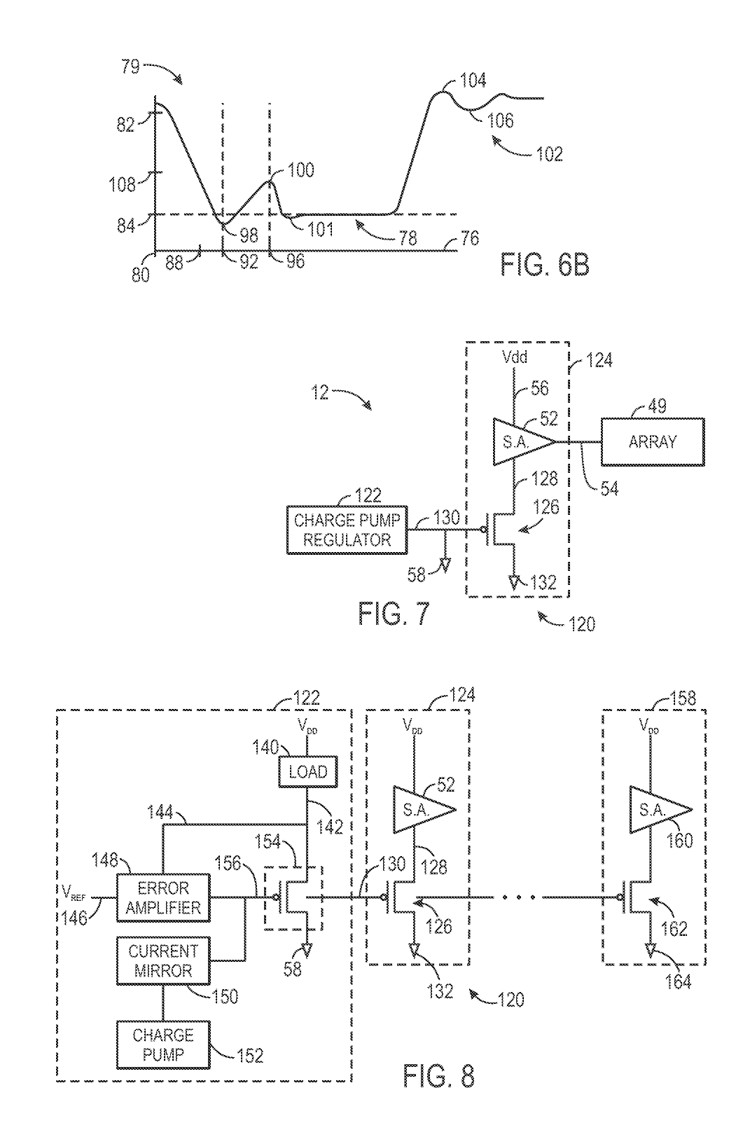

One illustration of a graph 70 depicting a ground bounce characteristic 72 is shown in FIG. 6A. The graph 70 illustrates a negative terminal voltage 74 that may be measured at a negative terminal (e.g., ground, −Vdd) relative to earth ground. The graph illustrates the negative terminal voltage 72 in relation to a timeline 76. Furthermore, the negative terminal voltage 74 may be compared to a desirable voltage 77 (e.g., 0 V) at which it is desirable to maintain the negative terminal of the chip. Additionally, FIG. 6B illustrates an output voltage 78 as a graph 79 of the chip in relation to the timeline 76. For example, the output voltage 78 may be the voltage measured as the amplified signal 54.

At an initial time 80, one or more gates within the integrated circuit are switched from HIGH to LOW, causing the output voltage 78 to switch from a logic high 82 to a logic low 84. The simultaneous switching of the multiple gates may cause a current surge at the negative terminal of the chip, thereby temporarily increasing the negative terminal voltage 74 to a ground bounce voltage peak 86 at time 88. When the current flows to earth ground, the negative terminal voltage 74 may overcompensate and drop to a negative terminal valley voltage 90 at time 92. In a similar manner, the negative terminal voltage may continue to oscillate about the desirable voltage 77 to yield one or more additional negative terminal peak voltages, such as the illustrated negative terminal peak voltage 94 occurring at time 96. Additionally, the oscillation of the negative terminal voltage 74 may produce additional negative terminal valley voltages. The number of the additional negative terminal peak voltages and valley voltages may vary according to the amplitude of the output voltage 78, total lead inductance, output edge rate, the number of gates simultaneously switching, characteristics of the ground path, and/or other factors. Absent another switching occurrence, the inductive ringing may cease, returning the negative terminal voltage 74 to a constant voltage, such as the desirable voltage 77.

As illustrated in FIG. 6B, the oscillation of the negative terminal voltage 74 affects the output voltage 78 of the integrated circuit. A change in the negative terminal voltage 74 creates an offset on the output voltage 78. Specifically, when the negative terminal voltage 74 decreases below the desirable voltage 77 at time 92, the output voltage 78 correspondingly decreases to output voltage valley 98 when measured relative to earth ground. In other words, as the negative terminal voltage 74 oscillates, the output voltage 78 oscillates from a desired voltage in a corresponding manner. Specifically, each additional negative terminal peak voltage 94 produces a corresponding additional output peak voltage 100, and each additional negative terminal valley voltage produces a corresponding output valley voltage 101.

Similar to the ground bounce characteristic 70, a voltage oscillation may occur at the positive terminal (e.g., Vdd) of the source amplifier 52 when one or more gates switch from a logic low to a logic high. This voltage oscillation creates a voltage bounce characteristic 102. The voltage bounce characteristic 102 includes an increase in the output voltage 78 to a voltage bounce peak 104 above the logic high voltage 82. The voltage bounce peak 104 is followed by voltage overcompensation to the voltage bounce valley voltage 106 due to voltage oscillation at the positive terminal of the source amplifier 52. Similar to the ground bounce characteristic 72, the voltage bounce characteristic 102 may include varying numbers of peaks and valleys before returning to output high voltage 82 according to the amplitude of the output voltage 78, total lead inductance, output edge rate, the number of gates simultaneously switching, characteristics of the ground path, and/or other factors.

Ground bounce is one of the main causes of false switching and diminished signal quality in electronics. False switching occurs when noise on an output signal causes the signal to pass a threshold voltage such as the threshold voltage 108. When the ground bounce causes the output signal to cross the threshold voltage to cause the receiving component (e.g., array 49) to improperly the output signal. For example, in CMOS circuitry using a 5V supply voltage, the threshold voltage may be 2.5 V. Accordingly, any voltage above 2.5V would be interpreted as a logic high, and any voltage below 2.5 V would be interpreted as a logic low. Returning to FIGS. 5A & 5B, the voltage oscillation at the output voltage 78 caused by the ground bounce characteristic 72 increases the possibility of false switching. Specifically, when the ground bounce characteristic 72 causes the ground bounce peak voltage 100 to exceed the threshold voltage 108 for the device, the desired output of the source amplifier 52 is a logic low, but the actual output of the source amplifier 52 will be interpreted by the display as a logic high. Similarly, if the voltage bounce valley voltage 106 decreases the output voltage 78 below the threshold voltage 108, the desired output voltage will be a logic high but will be interpreted as a logic low.

FIG. 7 is a schematic view of a source amplifier circuit 120 that may be found in the display 12. The source amplifier circuit 120 includes a charge pump regulator 122, a slave circuit 124, and a common return 58 that may combine to reduce and/or eliminate ground bounce. The slave circuit 124 includes a source amplifier 52 supplying an amplified signal 54, a voltage 56, a switch 126, and a negative terminal voltage 128. In certain embodiments, the source amplifier 52 may supply the amplified signal 54 to the display array 49 or another suitable electronic component. The charge pump regulator 122 supplies a gate voltage 130 to the switch 126. In the current embodiment, the switch 126 is a PMOS type transistor that decouples the slave circuit 124 from a ground 132 when the gate voltage 130 above the threshold voltage for the PMOS. Similarly, when the gate voltage 130 is below the threshold voltage for the PMOS, the switch 126 couples the negative terminal to the ground 132. By coupling and decoupling the master circuit 124 to and from the ground 132, any ground bounce occurring at the source amplifier 52 may be prevented from negatively affecting the other circuitry 60 through a common connection (e.g., common return 58).

FIG. 8 is a detailed schematic view of the source amplifier circuit 120. As illustrated, the charge pump regulator 122 of the source amplifier circuit 120 includes a load 140, an emulation voltage 142, a feedback loop 144, a reference voltage 146, an error amplifier 148, a current mirror 150, a charge pump 152, and a pass element 154. In certain embodiments, the load 140 may be configured to produce an emulation voltage 142 that emulates the negative terminal voltage 128. That is, in such embodiments, the emulation voltage 142 may be substantially equivalent to the negative terminal voltage 128. Alternatively, some embodiments may include an emulation voltage 142 that is proportional to the negative terminal voltage 128. The emulation voltage 142 is supplied to the error amplifier 148 through the feedback loop 144. Additionally, as discussed below, the error amplifier 148 receives the reference voltage 146 to compare the emulation voltage 142 to the reference voltage 146. As discussed below, the error amplifier 148 supplies a compensation voltage 156 which the error amplifier 148 adjusts toward a selected voltage value (e.g., voltage above or below the threshold voltage for a switch). To produce the compensation voltage 156, the error amplifier 148 utilizes a voltage from the charge pump 152 at a current set by the current mirror 150 to adjust the compensation voltage 156.

The current mirror 150 may be utilized to adjust an amount of current utilized by the error amplifier 148. Additionally, the charge pump 152 supplies a voltage to be utilized by the error amplifier 148. As discussed below, voltages supplied by charge pumps (e.g., charge pump 152) are designed to be constant but may be noisy due to dropping of the signal caused by the load. To reduce noise oscillations, the current mirror 150 isolates the charge pump 152 from the error amplifier 148 by providing a high impedance path from the error amplifier 148 to the charge pump 152.

When the pass element 154 receives the compensation voltage 156 at a particular value, the pass element 154 may propagate a gate voltage 130 to one or more slave circuits 124, 158. Each slave circuit 124, 158 includes a source amplifier 160, a switch 162, and a ground connection 164. In certain embodiments, when the gate voltage 130 is propagated to the slave circuits 124, 158 as a voltage lower than the threshold voltage of the switch 162, the switch 162 (e.g., PMOS transistor) couples the negative terminal of the source amplifier 160 to the ground connection 164. In other embodiments, the switch 162 (e.g., NMOS) may couple the source amplifier 160 to the ground connection 164, when the gate voltage 130 is higher than the threshold voltage of the switch 126. Further, some embodiments include a ground connection 164 coupled to the ground 132 and/or the common return 58. By selectively coupling and decoupling the source amplifiers from ground connections, the source amplifier circuit 120 enables the discharge of any charge on the negative terminal of the source amplifiers without affecting other circuitry 60 within the electronic device 10.

In other words, when the when the negative terminal voltage 128 fluctuates from a desired value (e.g., OV), the emulation voltage 142 also fluctuates. This fluctuation of the emulation voltage 142 causes the error amplifier 148 to vary the compensation voltage 156 to the pass element 154. The pass element 154 may then propagate the gate voltage 130 to the one or more slave circuits 124, 158. In certain embodiments, when the compensation voltage 156 is supplied, the switches 126 and 162 may couple the respective source amplifiers 52 and 160 to grounds 132 and 164 to discharge any voltage accumulated at the negative terminal of the source amplifiers 52 and 160. Alternatively, some embodiments may apply the gate voltage 130 to enable the switches 126 and 162 to decouple the respective source amplifiers 52 and 160 from the respective ground connections.

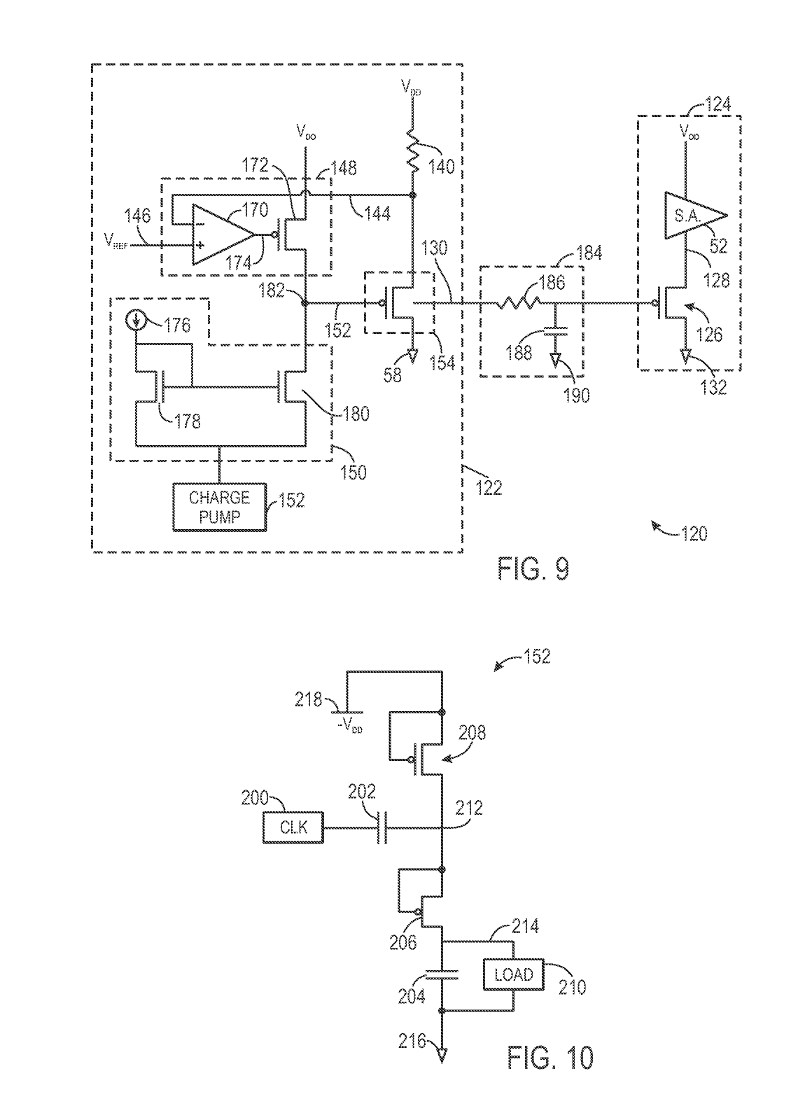

FIG. 9 is a more detailed schematic view of the source amplifier circuit 120. In the illustrated embodiment, no slave circuits 158 are included, but certain embodiments include one or more slave circuits 158 driven by the gate voltage 130. As illustrated, the load 140 may be a resistor (e.g., variable load resistor) chosen to produce an emulation voltage 142 that represents the negative terminal voltage 128. Additionally or alternatively, certain embodiments produce the emulation voltage 142 using other suitable electronic components. Other embodiments may supply the negative terminal voltage 128 directly from the negative terminal of the source amplifier 52.

The error amplifier 148 includes an op-amp 170 and an enhancement transistor 172. As previously discussed, the error amplifier 148 receives the reference voltage 146 and the feedback loop 144 delivering the emulation voltage 142. Both the emulation voltage 142 and the reference voltage 146 are supplied to the op-amp 170. The op-amp 170 then compares the reference voltage 146 to the emulation voltage 142. Any difference between the two voltages generates an error compensating voltage 174. The error compensating voltage 174 then enters the power stage of the error amplifier (e.g., enhancement transistor 172). The enhancement transistor 172 amplifies the error compensating voltage 174 to a level necessary to drive the pass element 154. The enhancement transistor 172 also utilizes the current and voltage supplied by the current source 150 and charge pump 152 to produce the compensation voltage 152. As previously discussed, when the compensation voltage 152 causes the pass element 154 to propagate the gate voltage 130 at a value above/below the threshold voltage of the pass element 154, the slave circuit 124 may be coupled to or decoupled from the ground 132. Similarly, in embodiments containing slave circuits 158, the source amplifiers 160 may be coupled or decoupled from ground 164

The illustrated current mirror 150 includes a current source 176, a first transistor 178, and a second transistor 180. As illustrated, the current mirror transistors 178 and 180 are NMOS transistors, but certain embodiments may include one or more other suitable components, such as BJT transistors. Additionally, as understood by one skilled in the art, certain embodiments of the current mirror 150 may include additional connections and components, such as op-amps and feedback loops. In the illustrated embodiment, the current source 176 supplies a reference current to the transistors 178 and 180. The illustrated embodiment uses matched transistors supplied with the voltage from the charge pump 152 to the output current at a node 182 to the reference current. Specifically, by supplying the reference current to the gates of both transistors in the illustrated configuration, the output current at the node 176 is equal to the reference current supplied by the current source 176.

The electrical properties of the signal at node 182 are determined by the error amplifier 148, the current mirror 150, and the charge pump 152. Specifically, as discussed below, the charge pump 152 provides a voltage to the current mirror. The current mirror 150 reduces oscillations in the voltage from the charge pump 152 while setting the amount of current to be used by the error amplifier 148. The error amplifier 148 then utilizes the voltage and current supplied from the current mirror 150 to adjust the error compensating voltage 174 to produce the compensated voltage 152.

Certain embodiments of the source amplifier circuit 120 may also include a filtering system 184. In such embodiments, the filtering system 184 may be a simple filter having a filter resistor 186, a filter capacitor 188, and a ground connection 190, where the filtering system 184 is configured to filter the gate voltage 130. Certain embodiments may couple the ground connection 190 to the common return 58, the ground 132, and/or the ground 164. Other embodiments may include any suitable filter known to one skilled in the art. Additionally, the illustrated embodiment shows a filtering system 184 filtering the gate voltage 130 between the pass element 154 and the master circuit 124. However, some embodiments may omit the filtering systems 184. Certain embodiments may include a filtering system 184 between the pass element 154 and each slave circuit 124, 158.

FIG. 10 illustrates an embodiment of the charge pump 152 of FIGS. 7 and 8. The illustrated charge pump 152 includes a clock 200, a flying capacitor 202, a reservoir capacitor 204, transistors 206 and 208, a load 210, voltage Vx 212, output voltage 214, a ground connection 216, and a voltage supply 218. Certain embodiments may couple the ground connection 216 to the common return 58, the ground 132, the ground 164, and/or the ground connection 190.

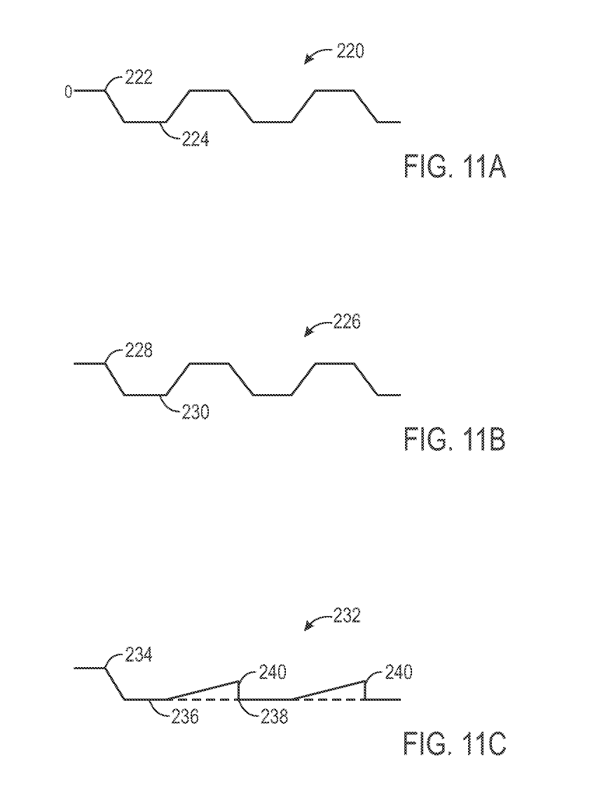

As shown in FIG. 11A, the clock 200 provides a clock signal 220 to the flying capacitor 202. For an embodiment of the charge pump 150 using PMOS transistors, the clock 200 may provide a signal that has a peak voltage 222 at 0 V and a negative peak 224 at −Vdd. As may be appreciated, a charge pump 152 using NMOS transistors may include a clock with a peak voltage of Vdd and a valley voltage of OV. Additionally, the voltage supply 218 may provide a voltage equivalent charge of the peak amplitude of the clock 200. Returning to FIG. 10, the transistors 206 and 208 from a switching network to switch the capacitors 202, 204 between charging and discharging states varying at the frequency of the clock signal 220. The switching of the transistors 206, 208 causes the flying capacitor 202 to shuttle the charge and the reservoir capacitor 204 to hold the charge and to filter the output voltage. The results of the charging and discharging of the flying capacitor 202 and the reservoir capacitor 204 can be measured at voltage Vx 212 and the output voltage 214.

FIG. 11B illustrates a Vx signal 226 measured as the voltage Vx 212 over time within the charge pump 152 and in relation to the clock 200. The Vx signal 226 includes a Vx peak 228 and a Vx valley 230. As may be appreciated, the Vx voltage 212 is essentially the clock signal 220 offset to the amplitude of the power supply 218. The Vx peak 228 may be approximately equal to −Vdd from the clock signal 220 and power supply (ignoring the threshold voltages of the transistors). Similarly, the Vx valley 230 may be approximately equal to twice the −Vdd (e.g., −2 Vdd) from the clock signal 220 and the power supply 218. This oscillation of the Vx signal 226 continues at the clock signal 220 frequency until the clock signal 220 is ceases oscillation.

FIG. 11C illustrates an output voltage signal 232 measured as the output voltage 214 over time. The output voltage signal 232 includes an initial voltage 234, a constant voltage 236, and oscillations 238. The initial voltage 234 is a voltage output before each capacitor has been fully charged. Once both capacitors 202, 204 have been charged, the output voltage signal 232 drops to a constant voltage 236 (e.g., −2 Vdd). Ideally, this constant voltage 236 would remain constant at an ideal voltage 238. However, due to the load 210, the output voltage 214 may droop to produce oscillations 240. As previously discussed, these oscillations 240 may be at least partially removed by the current mirror 150.

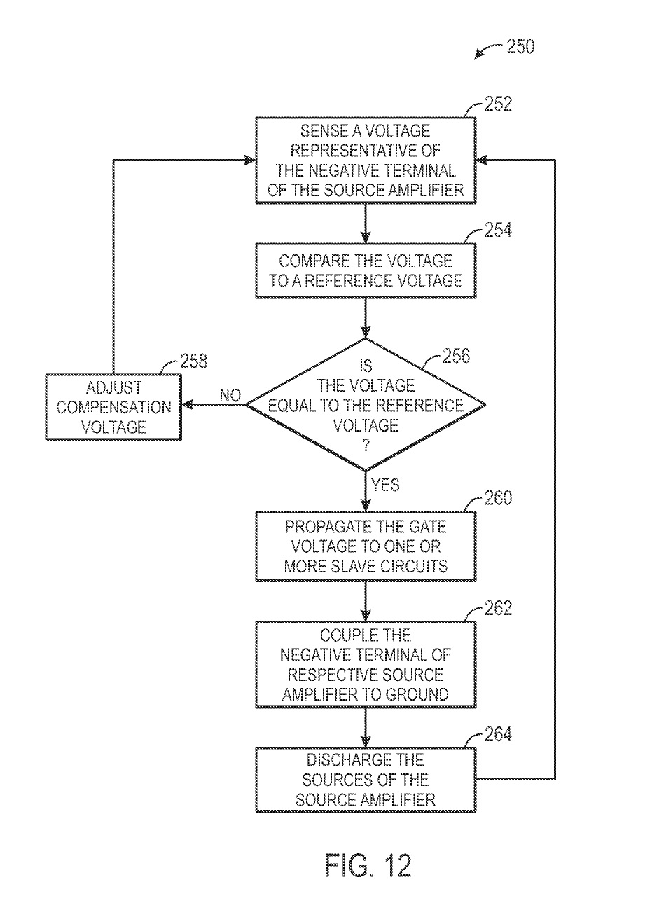

FIG. 12 is a block diagram of a method 250 of reducing ground bounce in accordance with aspects of the present disclosure. The method 250 includes sensing a voltage (e.g. emulation voltage 142) representative of the negative terminal of the source amplifier (block 252). For example, the source amplifier may be the source amplifier of the slave circuit 124. In other words, the circuit from which the voltage is sensed is the slave circuit 124 capable of generating the negative terminal voltage 128 from which all potential slave circuits 158 will be driven by the charge pump regulator 122. In certain embodiments, the voltage may be emulated using various electronic components or may represent the voltage at the negative terminal through a direct connection.

The method 250 further includes comparing the sensed voltage to a reference voltage (block 254). In certain embodiments, this comparison may be performed by an operational amplifier 170 or another suitable electronic component. In some embodiments, this comparison will return some value that contains information about the comparison. For example, if the comparison is performed by a differential amplifier, the output voltage of the differential amplifier may be negligible. After comparing the voltages, the method 250 includes determining whether the sensed voltage is equal to the reference voltage (block 256). For example, if the output of a differential amplifier is determined to be substantially negligible.

If it is determined in block 256 that the sensed voltage is not equal to the reference voltage, the compensation voltage is adjusted (block 258). In certain embodiments, this compensation voltage is modified by the error amplifier 148, utilizing a voltage at a certain current determined by the charge pump 152 and the current mirror 150. In other embodiments, the voltage and current supplied to the error amplifier 148 may utilize other inputs to generate the compensation voltage. Further, this adjustment to the compensation voltage may be an increase or decrease of the compensation voltage to block propagation of the gate voltage. After the voltage adjustment is performed, the method 250 returns to block 252.

If it is determined in block 256 that the sensed voltage is equal to the reference voltage, the gate voltage is propagated to one or more slave circuits 124, 158 (block 260). In certain embodiments, the gate voltage is the output of a pass element 154 receiving the compensation voltage. The gate voltage propagated to the slave circuits 124, 158 enables the slave circuits 124, 158 to couple the negative terminal of respective source amplifiers 52, 160 to ground (e.g., ground connection 188 common return 58, or ground 132 or 164) (block 262). In certain embodiments, the slave circuits 124, 158 may couple the negative terminals of the source amplifiers with switches configured to switch upon receiving the propagated gate voltage. By coupling the negative terminals of the respective source amplifiers to ground, the method 250 enables the slave circuits discharge the source of the source amplifiers. Additionally, by enabling the discharge of the sources of the source amplifiers using selective switching, the method enables the negative terminals of the source amplifiers to return to the ground voltage without propagating ground bounce to other components (e.g., other circuitry 60). Additionally, this coupling may remove any ground bounce or floating ground signal quality issues occurring at each of the source amplifiers. By coupling the negative terminals of the slave circuits to ground only when receiving the propagated gate voltage, the affect of ground bounce on one circuit may not be propagated to other circuitry within the electronic device.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A system for reducing ground bounce comprising:
at least one source amplifier circuit comprising:
a source amplifier; and
a switch configured to toggle the coupling of the source amplifier to a common return; and
a charge pump regulator configured to emulate a voltage from the at least one source amplifier and to toggle the switch based on the emulated voltage.

2. The system of claim 1, wherein the charge pump regulator comprises an error amplifier, a charge pump, and a current mirror.

3. The system of claim 2, wherein the charge pump is configured to provide a supply voltage to the current mirror.

4. The system of claim 3, wherein the current mirror is configured to receive the supply voltage from the charge pump and to supply a current to the error amplifier.

5. The system of claim 1, wherein the charge pump regulator is configured to receive a reference voltage and to toggle the switch when the reference voltage is substantially equal to the emulated voltage.

6. A display for an electronic device comprising:
a display array;
a plurality of source amplifiers each configured to supply an amplified signal to drive the display array;
a plurality of switches each configured to toggle the coupling of a respective one of the plurality of source amplifiers to a common return; and
a charge pump regulator configured to emulate a voltage from one of the plurality of source amplifiers and to toggle the switch based on the emulated voltage.

7. The display of claim 6, wherein the display array comprises a TFT layer.

8. The display of claim 6, wherein the display array comprises an array of pixels configured to receive a signal from the plurality of source amplifiers and to display an image.

9. The display of claim 6, wherein the emulated voltage is configured to emulate a voltage of the negative terminal of one of the plurality of source amplifiers.

10. The display of claim 6, wherein the plurality of source amplifiers are configured to couple to ground through the common return.

11. The display of claim 6, wherein the charge pump regulator comprises an error amplifier, a charge pump, and a current mirror.

12. The display of claim 11, wherein the charge pump is configured to provide a supply voltage to the current mirror.

13. An electronic device comprising
one or more processors;
one or more input structures configured to transmit input signals to the one or more processors;
a display operably coupled to the one or more processors, wherein the display comprises:
a display array;
a plurality of source amplifiers configured to supply amplified signals to drive the display array;
a plurality of switches each configured to toggle the coupling of a respective one of the plurality of source amplifiers to a common return; and
a charge pump regulator configured to emulate a voltage from one of the plurality of source amplifiers and to toggle the plurality of switches based on the emulated voltage.

14. The electronic device of claim 13, wherein the charge pump regulator comprises an error amplifier, a charge pump, and a current mirror.

15. The electronic device of claim 13, wherein the emulated voltage is configured to emulate a voltage from one of the plurality of source amplifiers using a variable load resistor.

16. The electronic device of claim 13, wherein the charge pump regulator is configured to toggle the plurality of switches to couple the plurality of source amplifiers to the common return when the emulated voltage is substantially equivalent to a reference voltage.

17. A method for reducing ground bounce comprising:
sensing a first voltage based on an amplifier voltage generated by a plurality of source amplifiers;
determining an amplitude of a second voltage with a charge pump regulator configured to compare the first voltage to a reference voltage; and
propagating the second voltage to a plurality of switches each configured to toggle the coupling of a respective one of the plurality of source amplifiers to a common return.

18. The method of claim 18, wherein the charge pump regulator comprises an error amplifier, a charge pump, and a current mirror.

19. The method of claim 18, comprising generating the first voltage to emulate the amplifier voltage using a load.

20. The method of claim 19, wherein the load is a variable load resistor.
